(19) United States
(12) Patent Application Publication
(10) Pub. No.: US 2012/0204722 A1
(43) Pub. Date: Aug. 16, 2012

(54) HARD DISK DRIVE FILTRATION DEVICE

(76) Inventor: Norman Watkins, Gilroy, CA (US)

(21) Appl. No.: 13/396,075

(22) Filed: Feb. 14, 2012

Related U.S. Application Data
(60) Provisional application No. 61/442,325, filed on Feb. 14, 2011.
(60) Provisional application No. 61/479,233, filed on Apr. 26, 2011.

(51) Int. Cl. B01D 46/00; B03C 3/00

(52) U.S. Cl. 96/55; 55/495; 55/486

(57) ABSTRACT

A hard disk drive filter which includes a tunable breather filter within a housing that can be easily removed and exchanged. The tunable breather filter provides multi-directional air flow through the filter.

### CROSS-REFERENCE TO RELATED APPLICATIONS

This application claims priority to provisional patent application having Ser. No. 61/442,325, filed Feb. 14, 2011, and provisional patent application having Ser. No. 61/479,233, filed Apr. 26, 2011, which are both herein incorporated by reference in their entireties.

### FIELD OF INVENTION

The present invention is directed to a filtration device for a hard disk drive and a method for making the filtration device. More specifically, the present invention is directed to a hard disk drive filtration device which includes a housing and a tunable breather filter contained within the housing that can be easily removed from, and exchanged within, the housing.

### BACKGROUND OF THE INVENTION

A hard disk drive (HDD) is a device used for storing and retrieving digital computer data that includes one or more rotating discs each coated with a magnetic material and a magnetic head for each disc that functions to write and read data from the disc. The discs are often referred to as platters and the magnetic heads are mounted on an actuator arm that moves the heads on an arc across the platters as the platters spin on a spindle.

Hard disc drives are classified as non-volatile, random access, digital, magnetic, data storage devices and have been the dominant device for secondary storage of data in computers for decades. Advances in hard disk drive recording capacity, cost, reliability, and speed have made them able to maintain this dominant position as secondary storage devices.

A hard-disk failure occurs when a hard disk drive malfunctions and the information stored on the hard disk drive cannot be accessed with a properly configured computer. One cause of hard-disk failure is a faulty air filter. Air filters on current hard disk drives function to equalize the atmospheric pressure and moisture between the hard-drive enclosure and its outside environment. If the hard disk drive filter fails to capture a dust particle or other particle contaminant, the particle can land on the platter thereby causing a head crash if the magnetic head sweeps over the particle. A head crash occurs when the internal read-and-write magnetic head of the hard disk device touches a platter. Each particle from a damaged platter and magnetic head that result from a head crash can cause a bad sector and result in sever data loss.

Many filter components and filter configurations have been designed in an effort to enhance hard disk drive performance and reduce hard disk drive failure. However, none of the current filter devices for hard disk drives include a filter media that can be tuned for different flow rates. In addition, none of the current filter devices for hard disk drives include a filter media that can be easily removed and exchanged without having to change the housing of the filter device. These features, along with other features of the hard disk drive filtration device of the present invention, reduce the costs for making a hard disk drive filtration device while enhancing the performance of the hard disk drive and reducing hard disk drive failure.

### SUMMARY OF THE INVENTION

The present invention is directed to a hard disk drive filtration device which includes a housing and a tunable breather filter contained within the housing. The tunable breather filter comprises a porous material that can be adjusted to control air flow through the filter by controlling the pore size and density of the porous material as well as the height or depth of the porous material. The porous material of the tunable breather filter results in multidirectional airflow through the filter.

In one exemplary embodiment of the hard disk drive filtration device of the present invention, the tunable breather filter may include a porous non-carbon material positioned on top of a non-porous carbon material. In another exemplary embodiment of the hard disk drive filtration device of the present invention, the tunable media filter may include a porous non-carbon material positioned on top of a porous carbon material. In yet other exemplary embodiments of the hard disk drive filtration device of the present invention, the different embodiments of the tunable media filter described above may further include one or more flow paths or trenches formed within the non-porous carbon material and/or the porous carbon material.

In still another exemplary embodiment of the hard disk drive filtration device of the present invention, the tunable breather filter may include a carbon material layer, which may be a porous or non-porous carbon, sandwiched between first and second layers of a non-carbon porous material. Further, the carbon material layer of the tunable breather filter may include one or more trenches or flow paths formed within it. In addition, the one or more trenches or flow paths formed within the carbon material layer may intersect with one another.

In yet another exemplary embodiment of the hard disk drive filtration device of the present invention, the housing may have a bottom with an opening contained therein and an open top. Moreover, in other exemplary embodiments of the hard disk drive filtration device of the present invention, the hard disk drive filtration device may include one or more of the following: a first adhesive layer having an opening therein positioned adjacent to the bottom of the housing, a filter membrane positioned on top of the first adhesive layer, a tunable breather media portion positioned on top of the filter membrane wherein the tunable breather media portion may comprise any one of the previously described embodiments of the tunable breather filter, a second adhesive layer having an opening therein positioned on top of the tunable breather media portion, a third adhesive layer positioned on top of the second adhesive layer having an opening therein, an metal layer having a labyrinth contained therein positioned on top of the third adhesive layer; a fourth adhesive layer positioned on top of the metal layer; and a release liner positioned on top of the fourth adhesive layer.

The present invention is also directed to a method for making a hard disk drive filtration device which includes the steps of forming a housing having a bottom with an opening therein and an open top, positioning a filter membrane adjacent to the bottom of the housing, forming an exchangeable tunable breather filter and positioning it on top of the filter membrane; positioning an adhesive layer on top of the tunable breather filter, and positioning a release liner on top of the adhesive layer. In addition, a spacer may be positioned between the filter membrane and the tunable breather filter.

There are several different methods for forming the exchangeable tunable breather filter. One exemplary method for forming the exchangeable tunable breather filter includes the steps of providing a carbon based absorption material and positioning a porous non-carbon tunable media on top of the carbon material. In addition, this exemplary method may also include the optional step of forming at least one flow path or trench within at least one surface of the carbon material. Another exemplary embodiment for forming the exchangeable tunable breather filter includes the steps of providing a porous tunable carbon material, positioning a porous non-carbon tunable media on top of the porous tunable carbon material, and laminating the porous non-carbon tunable media to the porous tunable carbon material. In addition, this exemplary method may also include the optional step of forming at least one flow path or trench within at least one surface, of the porous tunable carbon material before laminating the non-carbon porous tunable media to the porous tunable carbon media. Alternatively, the exchangeable tunable breather filter may be formed from a porous tunable carbon material alone and may also include one or more flow paths or trenches formed within one or more surfaces of the porous tunable carbon material. The exchangeable tunable breathable filter made from a porous tunable carbon material may be manipulated and/or adjusted to control flow rates by adjusting the pore size, density, and height or depth of the porous carbon material.

Yet another exemplary method for making the hard disk drive filtration device of the present invention includes the steps of forming a housing having a bottom with an opening therein and an open top, placing a first adhesive layer with a central opening adjacent to the bottom of the housing, placing a filter membrane on top of the first adhesive layer, forming a tunable breather filter and placing it on top of the filter membrane, placing a second adhesive layer with a central opening on top of the tunable breather filter, placing a third adhesive layer on top of the second adhesive layer, placing a metal layer having a labyrinth on top of the third adhesive layer, placing a fourth adhesive layer on top of the metal layer, and placing a release liner on top of the fourth adhesive layer. This exemplary method may also include the step of forming at least one flow path or trench within at least one surface of tunable breather filter when forming the tunable breather filter. It should also be understood that the exchangeable breather filter may be formed by any number of methods including all of the previously described methods for forming the tunable breather filter. In addition, the tunable breather filter may be formed by stacking any number of layers of porous or non-porous carbon material and porous non-carbon material in varying orders and the carbon layer may be further formed by forming one or more flow paths or trenches in one or more surfaces of the carbon layer. Moreover, it should be further understood that some of the various adhesive layers and/or the metal layer may be omitted while making other embodiments the hard disk drive filtration device.

The exchangeable tunable breather filter portion of the hard disk drive filtration device of the present invention can be made such that the exchangeable tunable breather filter can be easily removed from the housing and exchanged with another tunable breather filter which is repositioned within the housing.

### BRIEF DESCRIPTION OF THE DRAWINGS

The subject invention will hereinafter be described in conjunction with the appended drawing figures, wherein like numerals denote like elements, and

FIG. 1 is a cross-sectional view of one exemplary embodiment of the tunable breather filter of the present invention shown positioned within a housing;

FIG. 2 is a cross-sectional view of another exemplary embodiment of the tunable breather filter of the present invention shown positioned within a housing;

FIG. 3 is a cross-sectional view showing the air flow through another embodiment of the tunable breather filter and its adjacent breathable filter membrane;

FIG. 4 is a top view of the breathable filter membrane that lies adjacent to the tunable breather filter of the present invention;

FIG. 5 shows an exploded view of one exemplary embodiment of the hard disk drive filtration device of the present invention along with a side view of the filtration device and top views of separate components that make up the filtration device;

FIG. 6 shows a top view of an exemplary embodiment of a portion of the filter of the present invention shown in FIG. 5 having a labyrinth or path embedded therein;

FIG. 7 is a cross-sectional view of FIG. 6 taken along line A-A of FIG. 6;

FIG. 8 shows an exploded view of another exemplary embodiment of the hard disk drive filtration device of the present invention along with a side view of the filtration device and top views of separate components that make up the filtration device;

FIG. 9 shows a top plan view of one embodiment of the tunable breather filter portion of the hard disk drive filtration device of the present invention having intersecting flow paths or trenches formed therein;

FIG. 10 is a cross-sectional view of the exemplary embodiment of the hard disk drive filtration device of the present invention shown in FIG. 8;

FIG. 11 is a flow chart showing one exemplary method for making the hard disk drive filtration device of the present invention;

FIG. 12 is a flow chart showing one exemplary method for forming a tunable breather filter for the hard disk drive filtration device of the present invention;

FIG. 13 is a flow chart showing another exemplary method for forming a tunable breather filter for the hard disk drive filtration device of the present invention; and

FIG. 14 is a flow chart showing another exemplary method for making the hard disk drive filtration device of the present invention.

### DETAILED DESCRIPTION

The hard disk drive filtration device of the present invention generally includes a housing and a tunable breather filter contained within the housing. The tunable breather filter may be removable and exchangeable within the housing and the tunable breather filter can control air flow through the device by being “tuned” or adjusted by controlling the pore size, density, and/or height/depth of the porous material that makes up the filter. Almost any porous material may be used, including porous carbon, that can function as a filter without releasing additional contaminants as a result of carrying out the filtering process. The present invention is also directed to various methods for making the hard disk drive filtration device of the present invention as well as various methods for making the tunable breather filter that comprises part of the hard disk drive filtration device.

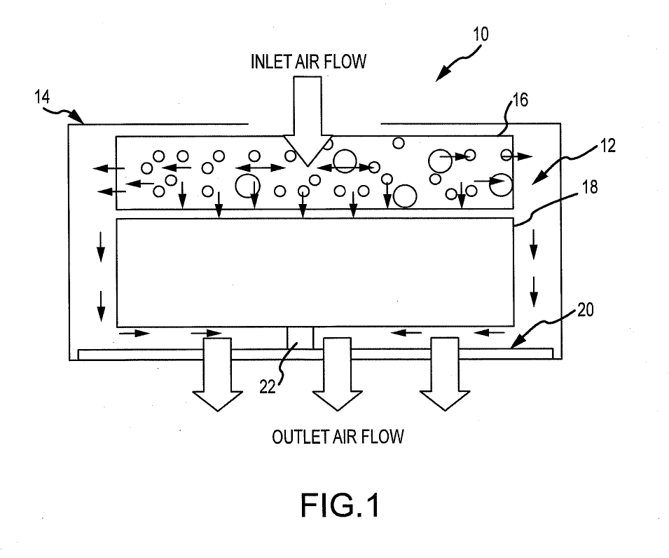

FIG. 1 shows a cross-sectional view of one exemplary embodiment of the tunable breather filter 12 of the present invention shown positioned within a housing 14. Tunable breather filter 12 includes a non-carbon porous tunable media portion 16 positioned over a non-porous carbon media portion 18. Air flows into the filtration device 10 and then through multiple channels within the non-carbon porous tunable media portion 16 which are created by the pores contained within the non-carbon porous tunable media portion 16 which can be adjusted by controlling the pore size, density, and/or height/depth of the porous non-carbon tunable media. Air flow through the filtration device is shown in FIG. 1 by arrows and the air flow goes through and out the sides and bottom of the non-carbon porous tunable media portion 16 and then around the top, sides and bottom of the non-porous carbon media portion 18 before existing the housing 14 after passing through a breathable filter membrane 20. A spacer 22 may be positioned between the bottom of the non-porous carbon media portion 18 and the breathable filter membrane 20.

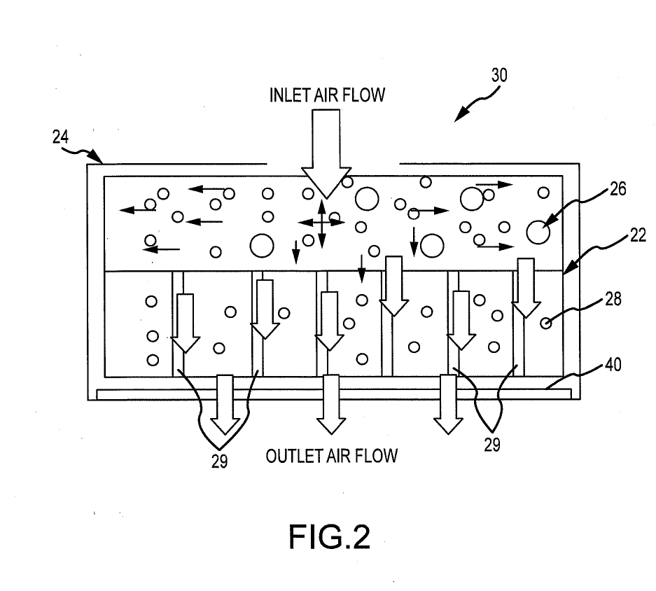

Another exemplary embodiment of the tunable breather filter 22 of the present invention shown positioned within a housing 24 is shown in cross-section view in FIG. 2. Tunable breather filter 22 includes a non-carbon porous tunable media portion 26 positioned over a porous carbon tunable media portion 28. Tunnels 29 may be formed within the porous carbon tunable media portion 28 to further assist in directing air flow through the filtration device 30. Further, the non-carbon porous tunable media portion 26 may be laminated to the porous carbon tunable media portion 28. Air flows into the filtration device 30 and then through multiple channels within the non-carbon porous tunable media portion 26 and the porous carbon tunable media portion 28 which are created by the pores contained within the non-carbon porous tunable media portion 26 and the porous carbon tunable media portion 28 which can be adjusted by controlling the pore size, density, and/or height/depth of the porous non-carbon tunable media and the porous carbon tunable media. Air flow through the filtration device is shown in FIG. 2 by arrows and the air flows multi-directionally throughout the non-carbon porous tunable media portion 26 and then into and through the porous carbon tunable media portion 28 before existing the housing 24 after passing through a breathable filter membrane 40.

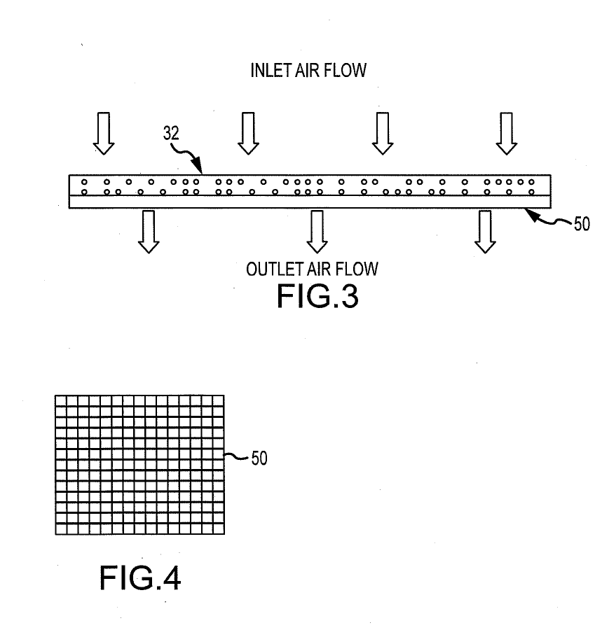

A cross-sectional view showing the air flow through another embodiment of the tunable breather filter 32 and its adjacent breathable filter membrane 50 are shown in FIG. 3. The tunable breather filter 31 comprises a media with small pores and/or clean porous material whose pore size and density can be adjusted as well as the height/depth of the material. The air flows through the tunable breather filter 32 and then through the adjacent breather filter membrane 50 which may comprise a polyester woven scrim or mesh. A top view of the breather filter membrane 50 is shown in FIG. 4.

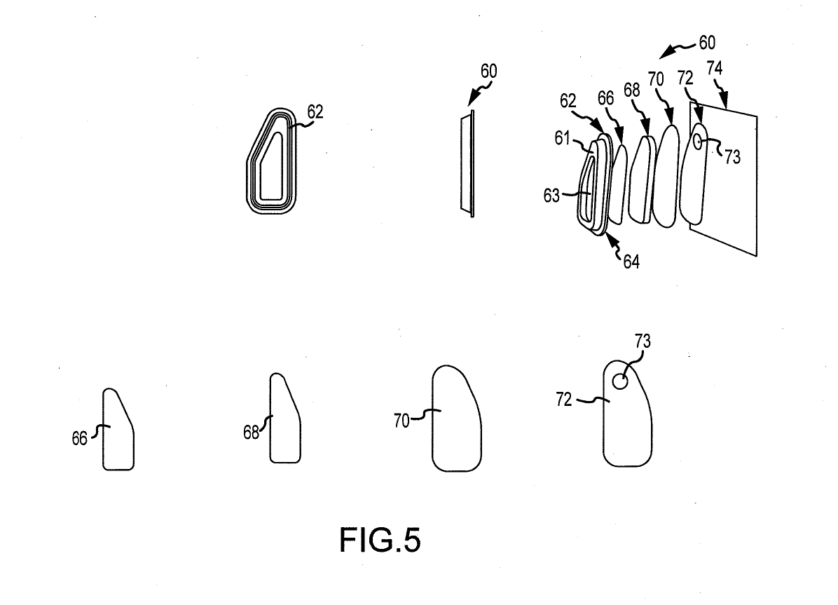

FIG. 5 shows an exploded view of one exemplary embodiment of the hard disk drive filtration device 60 of the present invention along with a side view of the filtration device 60 and top views of separate components that make up the filtration device 60. Hard disk drive filtration device 60 includes a housing 62 having a bottom 61 with an opening 63 therein and an open top 64, a breather filter membrane 66 positioned adjacent to the bottom of the housing 62 within the housing 62, a carbon based absorption material 68 positioned on top of the breather filter membrane 66, a tunable breather filter element 70 positioned on top of the carbon based absorption material 68, an adhesive layer 72 having an opening 73 therein positioned on top of the tunable breather filter element 70, and a release liner 74 positioned on top of the adhesive layer 72.

Housing 62 may be made from materials having an electrostatic discharge (ESD), intrinsic dissipative properties (IDP), or other like materials. Electrostatic discharge materials are important inside the hard disk drive because of the potential for non-ESD materials to create a charge that could damage the read/write heads contained within the hard disk drive. The housing material may be comprised completely of ESD material, ISP material, or the like, or the housing material may be coated with ESD material, ISP material or the like using any number of coating methods including deposition methods. The housing material may contain nano-tubes, carbon, graphite or other ESD dissipative fillers. Housing 62 can be vacuum formed or formed using other thermal forming processes. These types of processes are typically low in cost. Vacuum forming the housing 62 is especially beneficial for high volume manufacturing because the process is able to produce large quantities of housings in a short period of time and the costs for vacuum forming tooling is much less than the costs for conventional plastic molding tooling. A hole tracking system can be incorporated into housing 62 for component placement accuracy and ease of manufacturing in high volume. In addition, housing 62 can have molded vacuum formed indentations that allow for maximum air flow through the filter portion of the filtration device 60.

As previously described above and with reference to FIGS. 1-3, the filter portion of the hard disk drive filtration device 60 of the present invention can take many forms. For example, the filter portion can be an ESD filter having a multi-channel breather element that is tunable. The multi-channel tunable breather media portion allows the airflow to be multi-directional and the multi-directional airflow allows air to flow into and around the carbon portion of the filter for better absorption and utilization of the carbon. The multi-channel tunable breather media can be tuned for different flow rates because the breather media contains porous material with adjustable pores that can control flow. Adjusting the pore size and the density of the porous filter material can control flow rates and adjusting the height of the porous filter material can also control flow rates. The porous feature of the multi-channel tunable breather media reduces the likelihood that it will get clogged easily with particulates and other contaminants. The multi-channel tunable breather media in the filter assembly can be easily changed without changing the entire housing of the hard disk drive filtration device because of the portable removable design of the filter portion in relation to the housing. PALL Corp. special flow media funnel type pores can be used for the tunable breather filter media to trap particulate and other foreign material. The tunable breather filter media portion in the device 60 can be rigid or non-rigid.

The multi-channel tunable breather media can be made of carbon and the air can pass directly from the outside of the hard disk drive device and flow through the carbon multi-channel tunable breather media thereby eliminating the need for a labyrinth channel. The filter flow rate through the carbon multi-channel tunable breather media can be controlled by carbon pore size and density. Alternatively, as previously described above, the multi-channel tunable breather media can be a combination of non-carbon and carbon material. Porous non-carbon and porous carbon materials can be laminated together and the flow rates of the two laminated multi-channel tunable breather medias can be controlled by varying pore size, density, and/or height/depth.

Exemplary embodiments of the tunable media are discussed at length in many portions of the summary and detailed description of the present invention and can include a carbon layer or sponge or any material where you can vary the pores of the material. Carbon used for the filter media can be specifically designed for optimum water and chemical absorption. In some materials, nitrogen gas can be used to make the pores. In addition to pore size and the material used, other variables for the tunable media include height and width. The tunable media is tuned during processing of the media but it is also contemplated that configurations and materials may be used for the tunable media that could allow a user to self adjust the tunable media after manufacturing.

Adhesive layer 72 may comprise SANA-STAT electrostatic discharge (ESD) adhesive which can be used for static control. Adhesive layer 72 may contain carbon nano-tubes, graphite, or other material for ESD conductivity. Release liner 74 may comprise SANA-STA electrostatic discharge (ESD) release liner which stops tribal charges when removing the filter from the liner.

Manufacturing processes for making the hard disk drive filtration device of the present invention may use tracking mechanisms on the housing and other filter components for better dimensional control and ease of manufacturing. Manufacturing processes may also use an optical alignment system for better dimensional control and Hepa filtration over manufacturing machines for particulate control.

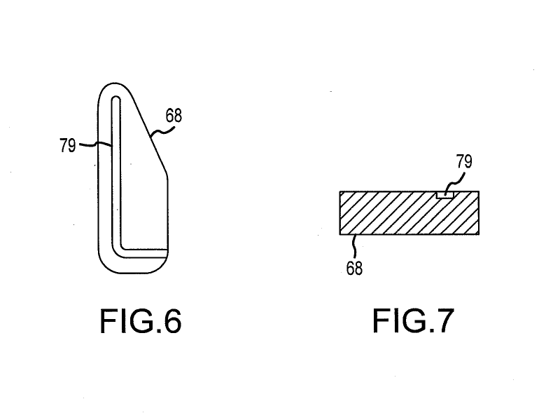

FIG. 6 shows a top view of an exemplary embodiment of a portion of the filter of the present invention shown in FIG. 5 having a labyrinth or path embedded therein and FIG. 7 is a cross-sectional view of FIG. 6 taken along line A-A of FIG. 6. Carbon based absorption material 68 shown in FIG. 5 may have one or more labyrinths or paths 79 embedded therein as shown in FIGS. 6 and 7. The labyrinth or path 79 shown embedded within a surface of carbon based absorption material 68 functions to further control and direct air flow.

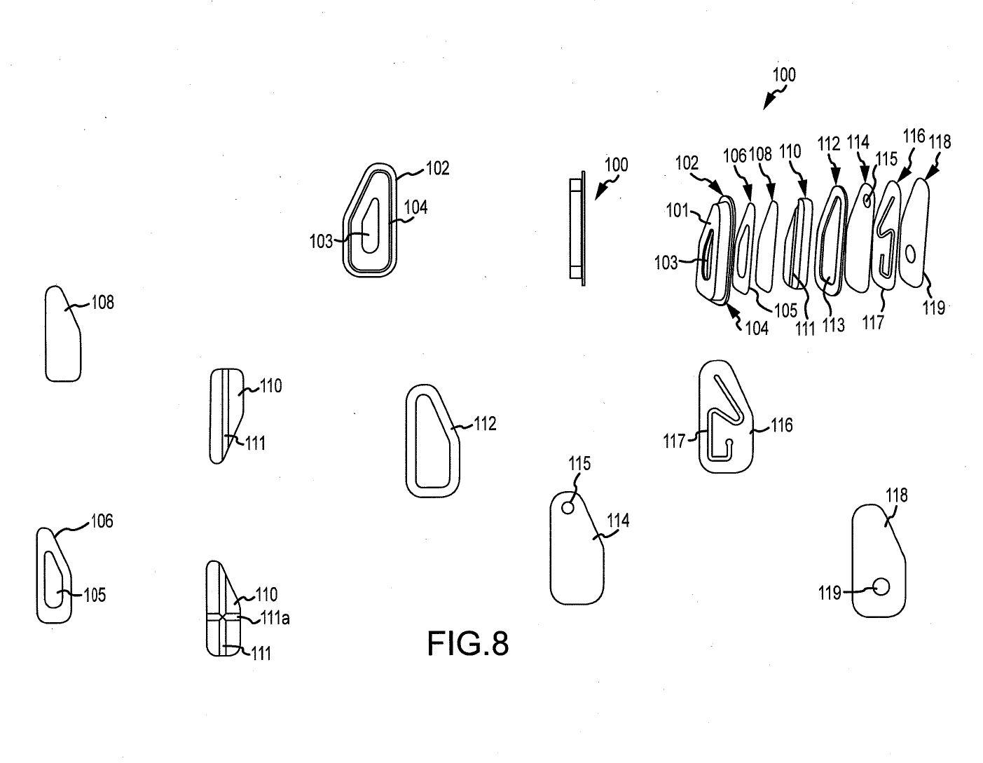

FIG. 8 shows an exploded view of another exemplary embodiment of the hard disk drive filtration device 100 of the present invention along with a side view of the filtration device and top views of separate components that make up the filtration device 100. Hard disk drive filtration device 100 includes a housing 102 having a bottom 101 with an opening 103 therein and an open top 104, a first adhesive layer 106 having a center opening therein 105 positioned adjacent to the bottom 101 of the housing 102 within the housing 102, a breather filter membrane 108 positioned on top of the first adhesive layer 106, a tunable breather media portion 110 positioned on top of the breather filter membrane 108, a second adhesive layer 112 having a central opening 113 therein positioned on top of the tunable breather media portion 110, a third adhesive layer 114 positioned on top of the second adhesive layer 112 wherein the third adhesive layer 114 has a small circular opening 115 positioned near a perimeter of the third adhesive layer to assist in further directed and controlling air flow, a metal layer 116 having a labyrinth 117 contained therein positioned on top of the third adhesive layer 114, a fourth adhesive layer 118 positioned on top of the metal layer 116 wherein the fourth adhesive layer has a circular opening 119 therein which is positioned over an end of the labyrinth 117 in the metal layer 116, and a release liner (not shown) positioned on top of the fourth adhesive layer 118. When the hard disk drive filtration device 100 is fully assembled, the opening 115 in the third adhesive layer 114 is positioned over an end of the labyrinth 117 in the metal layer 116 which is opposite that end of the labyrinth 117 where the opening 119 in the fourth adhesive layer 118 is positioned.

In the exemplary embodiment of the hard disk drive filtration device 100 shown in FIG.

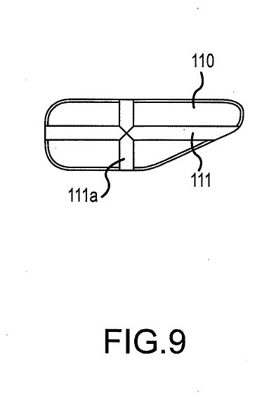

8, the tunable breather media portion 110 is carbon-based and has at least one flow path or trench 111 embedded within its surface. As further shown in FIGS. 8 and 9, tunable breather media portion 110 may have more than one flow path or trench (111, 111a) embedded in its surface where the flow paths or trenches intersect with one another. It should also be understood that the tunable breather media portion 110 in hard disk drive filtration device 100 may alternatively comprise any of the exemplary embodiments of the tunable breather filter previously described throughout this specification.

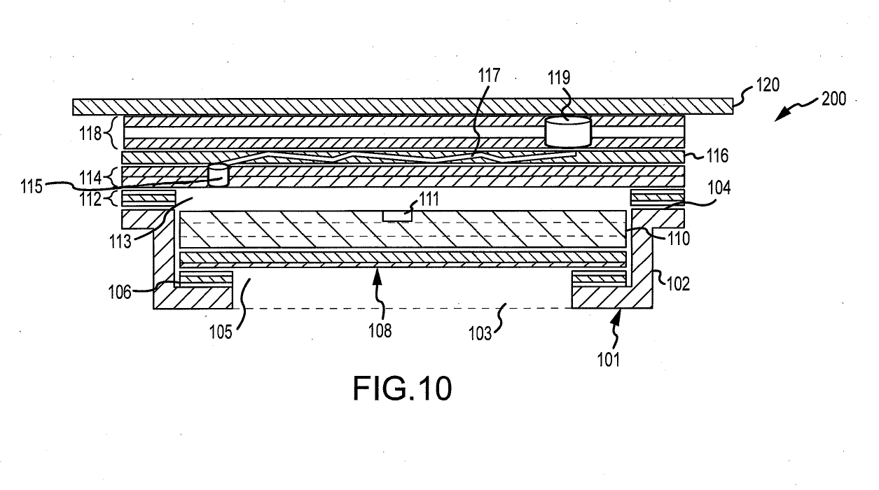

FIG. 10 is a cross-sectional view of the exemplary embodiment of the hard disk drive filtration device of the present invention shown in FIG. 8. As previously described above with reference to FIG. 8, hard disk drive filtration device 100 includes a housing 102 having a bottom 101 with an opening 103 therein and an open top 104, a first adhesive layer 106 having a center opening therein 105 positioned adjacent to the bottom 101 of the housing 102 within the housing 102, a breather filter membrane 108 positioned on top of the first adhesive layer 106, a tunable breather media portion 110 having at least one flow path or trench 111 embedded therein positioned on top of the breather filter membrane 108, a second adhesive layer 112 having a central opening 113 therein positioned on top of the tunable breather media portion 110, a third adhesive layer 114 positioned on top of the second adhesive layer 112 wherein the third adhesive layer 114 has a small circular opening 115 positioned near a perimeter of the third adhesive layer to assist in further directed and controlling air flow, a metal layer 116 having a labyrinth 117 contained therein positioned on top of the third adhesive layer 114, a fourth adhesive layer 118 positioned on top of the metal layer 116 wherein the fourth adhesive layer has a circular opening 119 therein which is positioned over an end of the labyrinth 117 in the metal layer 116, and a release liner 120 positioned on top of the fourth adhesive layer 118. When the hard disk drive filtration device 100 is fully assembled, the opening 115 in the third adhesive layer 114 is positioned over an end of the labyrinth 117 in the metal layer 116 which is opposite that end of the labyrinth 117 where the opening 119 in the fourth adhesive layer 118 is positioned.

The breathable filter membrane 108 may comprise a breathable ePTFE membrane and a polyethylene terephthalate (PTE) carrier is used to laminate the ePTFE filter membrane 108 to the tunable breather media portion 110. The metal layer 116 may be comprised of aluminum and the labyrinth 117 may be copper etched. A tunable breather media filter comprising carbon may have a flow path or trench 111 that is molded into the carbon portion of the filter or vacuum formed into the carbon portion of the filter. The molded or vacuum formed flow path/trench can be tuned to control air flow and humidity inside the filtration device.

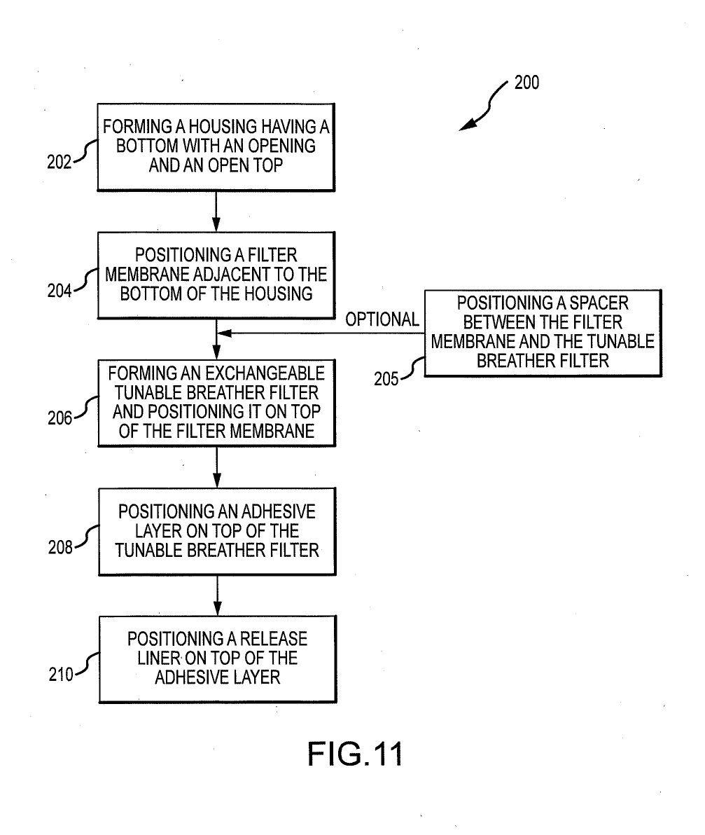

FIG. 11 is a flow chart showing one exemplary method 200 for making the hard disk drive filtration device of the present invention. First, a housing is formed having a bottom with an opening and an open top in step 202. In step 204, a filter membrane is positioned adjacent to the bottom of the housing within the housing and in step 206, an exchangeable tunable breather filter is formed and then positioned on top of the filter membrane. The housing may be formed of any number of materials as previously described including a polycarbonate. The tunable breather media may be formed from a number of different materials as previously described and can then be tuned by adjusting the pore size, density, and/or depth of the materials to control air flow. A spacer may be optionally positioned between the filter membrane and the tunable breather filter before positioning the tunable breather filter as shown in step 205. An adhesive layer is then positioned on top of the tunable breather filter in step 208 and a release liner is positioned on top of the adhesive layer in step 210.

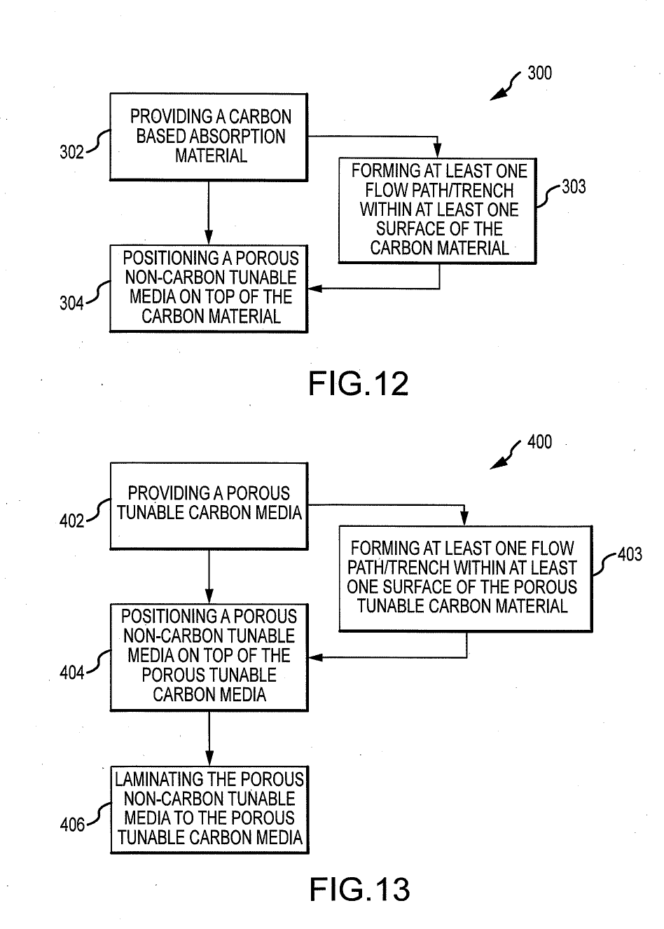

FIG. 12 is a flow chart showing one exemplary method 300 for forming a tunable breather filter for the hard disk drive filtration device of the present invention. The method 300 includes providing a carbon based absorption material in step 302 and then positioning a porous non-carbon tunable media on top of the carbon material in step 304. The method also includes the optional step of forming at least one flow path or trench within at least one surface of the carbon material as shown in step 303. Before positioning the carbon and non-carbon layers, the porous non-carbon media can be tuned by adjusting the pore size, density, and/or depth of the material to control air flow.

A flow chart showing another exemplary method for forming a tunable breather filter for the hard disk drive filtration device of the present invention is shown in FIG. 13. The method 400 includes providing a porous tunable carbon media in step 402 and then positioning a porous non-carbon tunable media on top of the porous tunable carbon media in step 404. The method also includes the optional step of forming at least one flow path or trench within at least one surface of the porous tunable carbon media as shown in step 403. Before positioning the porous carbon and porous non-carbon layers, each layer can be tuned by adjusting the pore size, density, and/or depth of the media to control air flow. Finally, the porous non-carbon tunable media is laminated to the porous tunable carbon media in step 406.

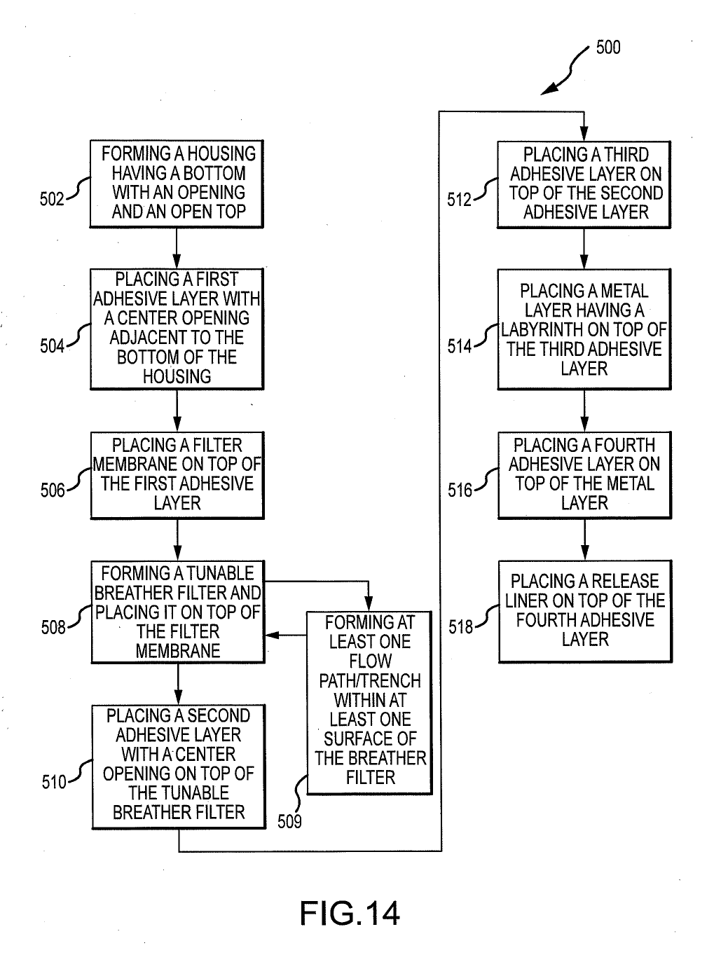

FIG. 14 is a flow chart showing another exemplary method 500 for making the hard disk drive filtration device of the present invention. First, a housing is formed having a bottom with an opening and an open top in step 502. In step 504, a first adhesive layer with a center opening is placed adjacent to the bottom of the housing within the housing. A filter membrane is placed on top of the first adhesive layer in step 506 and a tunable breather filter is formed and then placed on top of the filter membrane in step 508. At least one flow path or trench may be formed within a surface of the tunable breather filter in step 509. In step 510, s second adhesive layer with a center opening is placed on top of the tunable breather filter and a third adhesive layer is placed on top of the second adhesive layer in step 512. A metal layer having a labyrinth is then placed on top of the third adhesive layer in step 514 and a fourth adhesive layer is placed on top of the metal layer in step 516. Finally, a release liner is placed on top of the fourth adhesive layer in step 518. When the hard disk drive filtration device is assembled, a hole in the third adhesive layer is aligned with one end of the labyrinth in the metal layer and a hole in the fourth adhesive layer is aligned with the other end of the labyrinth in the metal layer.

Current prior art filter devices use PYFE for the outer housing or shell of the filter device. This material is expensive and can easily get damaged during handling and manufacturing. The current prior art also uses a special adhesive that is mandatory to stick to PTFE. This adhesive is expensive and made by very few manufacturers. Further, since PTFE is very hard to adhere to, the bond strength of the PTFE to other filter components is not very good thereby causing potential filter breakage or bond failure. The hard disk drive filtration device of the present invention uses non PTFE materials for its housing and the housing can be vacuum formed. The hard disk drive filtration device of the present invention which includes a multiple multi-directional path using tunable media and a vacuum formed (or other formed) non-PTFE housing enables stable bonding of filter components with reduced chance of breakage and failure of the filter device.

The detailed description of exemplary embodiments of the invention herein shows various exemplary embodiments and the best modes, known to the inventor at this time, of the invention. These exemplary embodiments and modes are described in sufficient detail to enable those skilled in the art to practice the invention and are not intended to limit the scope, applicability, or configuration of the invention in any way. Rather, the following disclosure is intended to teach both the implementation of the exemplary embodiments and modes and any equivalent modes or embodiments that are known or obvious to those reasonably skilled in the art. Additionally, all included figures are non-limiting illustrations of the exemplary embodiments and modes, which similarly avail themselves to any equivalent modes or embodiments that are known or obvious to those reasonably skilled in the art.

Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters, or other operating requirements without departing from the scope of the instant invention and are intended to be included in this disclosure.

1. A hard disk drive filtration device comprising a housing and a tunable breather filter contained within the housing.

2. The hard disk drive filtration device of claim 1 wherein the tunable breather filter is removable and exchangeable within the housing.

3. The hard disk drive filtration device of claim 1 wherein the tunable breather filter has multiple channels.

4. The hard disk drive filtration device of claim 1 wherein the tunable breather filter comprises a porous material having adjustable pores.

5. The hard disk drive filtration device of claim 4 wherein the adjustable pores are adjusted by controlling pore size and density of the porous material.

6. The hard disk drive filtration device of claim 4 wherein the porous material comprises at least one of a carbon material and a non-carbon material.

7. The hard disk drive filtration device of claim 6 wherein the adjustable pores are adjusted by controlling pore size and density of the porous material.

8. The hard disk drive filtration device of claim 6 wherein the tunable breather filter comprises a non-carbon tunable media portion positioned over a carbon tunable media portion wherein the non-carbon tunable media portion and the tunable media portion are laminated to one another.

9. The hard disk drive filtration device of claim 8 wherein the carbon tunable media portion includes at least one flow path embedded into the carbon tunable media portion.

10. The hard disk drive filtration device of claim 8 wherein the carbon tunable media portion includes at least one flow path embedded within the carbon tunable media portion wherein the flow path is formed by a vacuum.

11. The hard disk drive filtration device of claim 4 further comprising an electrostatic discharge adhesive portion located adjacent the tunable breather filter.

12. The hard disk drive filtration device of claim 11 further comprising an electrostatic discharge release liner located adjacent to the electrostatic discharge adhesive portion.

13. A hard disk drive filtration device comprising:
a housing having a bottom with an opening contained therein and an open top;
a first adhesive layer having a center opening therein positioned adjacent to the bottom of the housing;
a filter membrane positioned on top of the first adhesive layer having an opening therein;
a tunable breather media portion positioned on top of the filter membrane;
a second adhesive layer having an opening therein positioned on top of the tunable breather media portion;
a third adhesive layer positioned on top of the second adhesive layer having an opening therein;
an metal layer having a labyrinth contained therein positioned on top of the third adhesive layer;
a fourth adhesive layer positioned on top of the metal layer; and
a release liner positioned on top of the fourth adhesive layer.

14. The hard disk drive filtration device of claim 13 wherein the tunable breather filter is removable and exchangeable within the housing.

15. The hard disk drive filtration device of claim 13 wherein the tunable breather filter comprises a porous material having adjustable pores.

16. The hard disk drive filtration device of claim 15 wherein the adjustable pores are adjusted by controlling pore size and density of the porous material.

17. The hard disk drive filtration device of claim 15 wherein the porous material comprises at least one of a carbon material and a non-carbon material.

18. The hard disk drive filtration device of claim 17 wherein the tunable breather media portion comprises a carbon media portion positioned between first and second non-carbon tunable media portions.

19. The hard disk drive filtration device of claim 18 wherein the carbon media portion includes at least one trench embedded therein.

20. The hard disk drive filtration device of claim 19 wherein the carbon media portion includes at least two trenches embedded therein wherein the two trenches intersect with one another.

21. The hard disk drive filtration device of claim 20 wherein the carbon media portion is tunable.

22. The hard disk drive of claim 13 wherein the metal layer comprises aluminum and the labyrinth is copper etched.

23. The hard disk drive of claim 13 wherein the third and fourth adhesive layers each have an opening therein and each of the openings are positioned over opposite ends of the labyrinth.
